(19) United States
(12) Patent Application Publication
(10) Pub. No.: US 2005/0244577 A1
(43) Pub. Date: Nov. 3, 2005

(54) Process for fabricating a carbon nanofiber/Cu composite powder by electroless Cu plating

(76) Inventors: In Soo Kim, Gyeongsangnam-do (KR); Sang Kwan Lee, Gyeongsangnam-do (KR)

Correspondence Address: EDELL, SHAPIRO & FINNAN, LLC, 1901 RESEARCH BOULEVARD, SUITE 400, ROCKVILLE, MD, 20850, US

(21) Appl. No.: 10/909,545

(22) Filed: Aug. 3, 2004

(30) Foreign Application Priority Data
Apr. 28, 2004 (KR) 10-2004-29636

(51) Int. Cl. B05D 7/00; B05D 3/02

(52) U.S. Cl. 427/212; 427/372.2

(57) ABSTRACT

The present invention relates to a process for fabricating a carbon nanofiber (CNF)/Cu composite powder by an electroless Cu plating, whereby the surface of carbon nanofiber is plated with Cu by an electroless Cu plating. The process includes: a first step 100 of dispersing and hydrophilic-treating a powder; a second step 200 of catalyzing the treated powder in the first step 100; a third step 300 of accelerating the treated powder in the second step 200; a forth step 400 of carrying out an electroless Cu plating the treated powder in the third step 300; a fifth step 500 of drying the treated powder in the forth step 400, and a sixth step 600 of heat-treatment of the treated powder in the fifth step 500. The present invention has the effects of simplifying the process, so that a manufacturing cost is reduced.

### BACKGROUND OF THE INVENTION

1. Field of the Invention

The present invention relates to a process for fabricating a composite powder, and more particularly, to a process for fabricating a carbon nanofiber (CNF)/copper (Cu) composite powder by an electroless Cu plating, whereby the surface of CNF is plated with Cu by the electroless Cu plating.

2. Description of the Related Art

A carbon nanofiber (CNF) has a high strength and elastic modulus, an excellent thermal-conductivity and electric-conductivity, etc. Recently, many researches for utilizing the CNF are being conducted, and the practical use of the CNF as a reinforcing fiber, which is prepared with various composite materials, is being considered.

Up to now, the practical use of carbon/copper composite material has been limited within the abrasion field. However, due to a high electric-conductivity and thermal-conductivity and a specific strength of the carbon/copper composite material, it is being recognized as a material that could be used as an electric contact material.

Such carbon/copper composite material has been manufactured by a liquid metal infiltration and a powder metallurgy. However, since the interfacial compatibility of a carbon fiber and copper (Cu) is poor, it is difficult to manufacture an excellent composite material without coating of a carbon fiber.

Various attempts for coating the surface of a carbon fiber with a metal, such as a chemical vapor deposition (CVD), a powder metallurgy, etc., have been tried. Also, an electroless plating process has been applied in many different fields of industries since it has many advantages.

However, there are a few researches for coating a carbon fiber with a copper through the above-described electroless copper plating, and the coating of the CNF is not widely known yet.

### SUMMARY OF THE INVENTION

Accordingly, the present invention is directed to a process for fabricating a CNF/Cu composite powder by an electroless Cu plating that substantially obviates one or more problems due to limitations and disadvantages of the related art.

An object of the present invention is to provide a process for fabricating a CNF/Cu composite powder by an electroless Cu plating, whereby the surface of the CNF is plated with a Cu by an electroless Cu plating.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a process for fabricating a carbon nanofiber (CNF)/copper (Cu) composite powder by an electroless Cu plating, the process comprising a first step of dispersing and hydrophilic-treating a powder; a second step of catalyzing the treated powder in the first step; a third step of accelerating the treated powder in the second step; a forth step of carrying out an electroless Cu plating on the treated powder in the third step; a fifth step of drying the treated powder in the forth step, and a sixth step of heat-treatment of the treated powder in the fifth step.

The powder in the first step is a CNF.

The first step is carried out with distilled water and an ultrasonic wave.

The second step is carried out with 0.2-3.0 g/Q palladium chloride (PdCl₂), 10-40 g/l tin chloride (SnCl₂) and 100-200 ml/l hydrochloric acid (HCl) at 40° C. for 3 minutes.

The third step is carried out with 750 ml distilled water and 150 ml sulfuric acid (H₂SO₄) at room temperature for 3 minutes.

The forth step is carried out by adding 0.05-0.3 g CNF per l to an electroless Cu plating solution and agitating the CNF and the electroless Cu plating solution at a temperature of 65° C. for 10 minutes.

The fifth step is carried out at 100° C. for 12 hours.

Also, the sixth step is carried out at 400° C. for 3 hours in vacuum state.

There are advantages that a process for fabricating a CNF/Cu composite powder in accordance with the present invention is simple, so that the manufacturing cost can be reduced.

The technology of an electroless Cu plating has been widely applied in a printed circuit board (PCB) since the 1960's. The electroless plating is that a film is formed by the spontaneous oxidation-reduction reaction of materials existing in a solution without a power source. And a plating solution is composed of a material including a cation of Cu such as a copper sulfate, a reducing agent such as a formaldehyde (HCHO), and additives for controlling pH, a solution-stability, etc.

In order to carry out a plating on a substrate by spontaneous oxidation-reduction reaction, first of all, the surface thereof should be activated. From the foregoing reason, prior to soaking the substrate in an electroless plating solution, the substrate is soaked in an activation bath in order to form a activated particles, which are fine particles such as a palladium, on the surface thereof. Accordingly, the characteristic of a copper film plated is dependent upon the size and density of these activated particles formed on the surface of the substrate.

Hereinafter, a preferred embodiment of a process for fabricating a CNF/Cu composite powder by an electroless Cu plating of the present invention will be described in detail with reference to the drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic flow chart of a process for fabricating a CNF/Cu composite powder by an electroless Cu plating in accordance with a preferred embodiment of the present invention;

FIG. 2 is a cross-sectional view of an electroless plating apparatus in order to fabricate a CNF/Cu composite powder by an electroless Cu plating in accordance with a preferred embodiment of the present invention;

FIG. 3A is a scanning electron microscope (SEM) photo of a CNF before the dispersion and hydrophilic-treatment in a process for fabricating a CNF/Cu composite powder by an electroless Cu plating in accordance with a preferred embodiment of the present invention;

FIG. 3B is a scanning electron microscope (SEM) photo of a CNF/Cu composite powder after a process for fabricating a CNF/Cu composite powder by an electroless Cu plating in accordance with a preferred embodiment of the present invention.

FIG. 3C is a scanning electron microscope (SEM) photo of a CNF/Cu composite powder, manufactured by a process for fabrication of a CNF/Cu composite powder by electroless Cu plating in accordance with a preferred embodiment of the present invention.

FIG. 4A is an X-ray diffraction spectrum of a CNF/Cu composite powder after a process for fabrication of a CNF/Cu composite powder by electroless Cu plating in accordance with a preferred embodiment of the present invention.

FIG. 4B is an X-ray diffraction spectrum of a CNF/Cu composite powder, manufactured by a process for fabrication of a CNF/Cu composite powder by electroless Cu plating in accordance with a preferred embodiment of the present invention.

### DETAILED DESCRIPTION OF THE INVENTION

Reference will now be made in detail to the preferred embodiments of the present invention, examples of which are illustrated in the accompanying drawings.

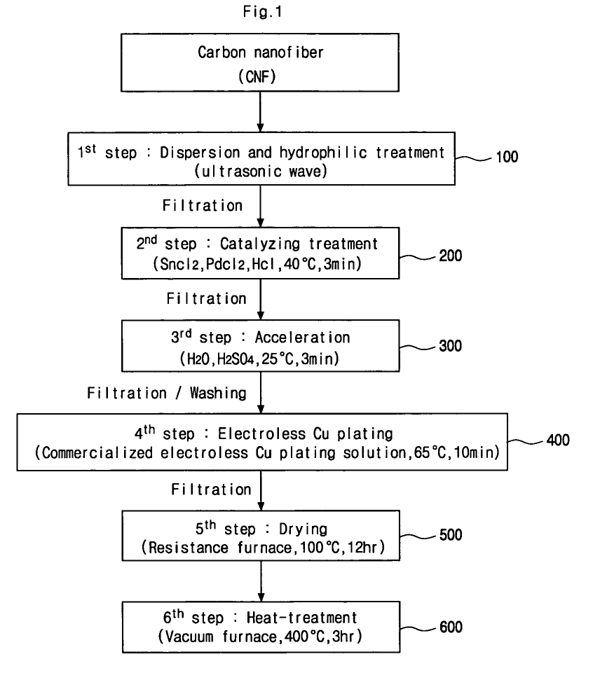

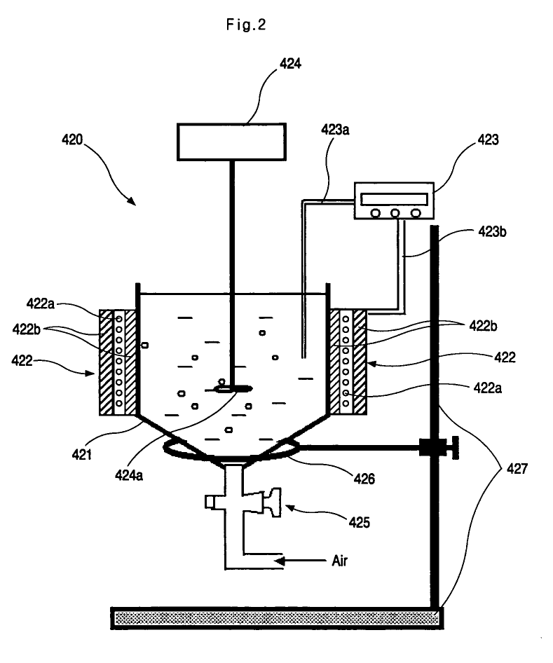

FIG. 1 is a schematic flow chart of a process for fabricating a CNF/Cu composite powder by an electroless Cu plating in accordance with a preferred embodiment of the present invention, and FIG. 2 is a cross-sectional view of an electroless plating apparatus for fabricating a CNF/Cu composite powder through an electroless Cu plating in accordance with a preferred embodiment of the present invention.

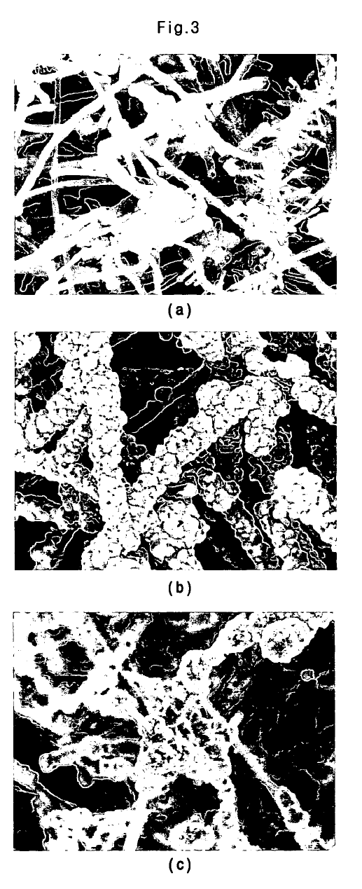

FIG. 3 shows scanning electron microscope (SEM) photos of a CNF powder before the dispersion and hydrophilic-treatment according to the present invention, and a CNF/Cu composite powder, manufactured by a process for fabricating a CNF/Cu composite powder by an electroless Cu plating in accordance with a preferred embodiment of the present invention.

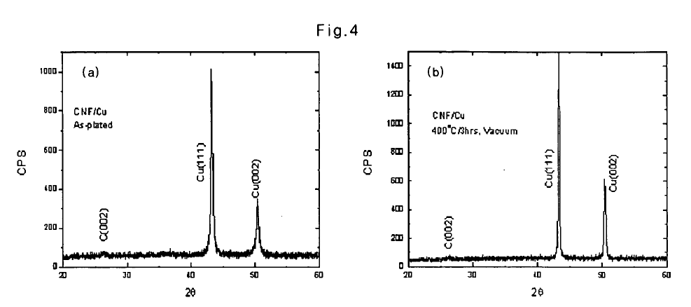

FIG. 4 shows X-ray diffraction spectrums of the CNF/Cu composite powders, manufactured by a process for fabricating a CNF/Cu composite powder by an electroless Cu plating in accordance with a preferred embodiment of the present invention.

As shown in these drawings, the process for fabricating a CNF/Cu composite powder through the electroless Cu plating includes the first step 100 where the CNF powder is dispersed using an ultrasonic cleaner (not shown) and goes through a hydrophilic-treatment.

In the first step 100, an appropriate amount of water is filled in the ultrasonic cleaner formed in a rectangular-shape bath, and then a beaker (not shown) filled with a distilled water is dipped into the ultrasonic cleaner. A power source is connected to the ultrasonic cleaner, and then a CNF powder is put in the beaker filled with distilled water, which is then stirred with a glass rod (not shown) until the CNF is dispersed in distilled water.

After the first step 100 of dispersing and hydrophilic-treating a CNF powder with an ultrasonic cleaner is completed, the beaker is taken out and filtrated with a filter (not shown).

The upper end of the filter is formed in a funnel-shape, and the lower end is formed with a space for storing the distilled water after filtrating a CNF powder, and a filter is placed at the lower portion having a funnel-shape in order to filtrate the CNF powder.

The CNF powder that has been filtered after treated through the first step is processed through a second step 200 in which a catalyzing treatment is applied in order to allow the Cu-plating on the surface thereof by precipitating catalyst particles such as a palladium.

In the second step 200, an appropriate amount of water is filled in a rectangular-shape bath (not shown) and the power source is connected to maintain the water at the temperature of 40° C., thereafter 100-200 ml/l hydrochloric acid is added to a solution comprising 0.2-3 g/l palladium chloride and 10-40 g/l tin chloride, which is then mixed. The mixed catalyzing solution is put in a beaker, which is then dipped into the aforementioned bathtub.

The CNF powder filtered after passing the first step 100 is introduced into the beaker having the catalyzing solution, and then stirred with a glass rod for 3 minutes.

After the second step 200 is completed, the same filtration procedure as the filtration conducted after the first step 100 is carried out with the filter.

The CNF powder that has been filtered after treated through the second step 200 is then treated through a third step 300 where an acceleration treatment is applied to efficiently perform the nucleation of Cu.

In the third step 300, a mixed solution of 750 mΩ of distilled water and 150 ml of a sulfuric acid (H₂SO₄) is put in a beaker (not shown), which is then maintained at room temperature (25° C.), and then the CNF powder is introduced therein, and stirred with a glass rod for 3 minutes.

After conducting the third step 300, the filtration is carried also out through the aforementioned filter, wherein the filtration is conducted twice to remove a sulfuric acid (H₂SO₄). That is, the distilled water is added into the filter as the filtering process is conducted twice, thereby the activated CNF powder is cleaned.

Thereafter, a forth step 400 of plating a copper (Cu) on the surface of CNF in a commercial electroless Cu plating solution (Macdermid, M185) is carried out.

As shown in FIG. 2, the forth step 400 is carried out in an electroless plating apparatus 420. The electroless apparatus 420 includes a plating bath 421 filled with a plating solution, a heating part 422 for heating the plating bath 420, a temperature controlling part 423 for monitoring the temperature of the plating bath 421 and supplying the power source to the heating part 422 in order to maintain the constant temperature, an agitator 424 mixing the plating solution in the plating bath 421, an air controlling part 425 for agitating the solution by air, which is connected to the lower end of the plating bath 421, a supporting part 426 for supporting the plating bath 421, and an installation part 427 which is connected to the supporting part 426.

The plating bath 421 is formed in the shape of a letter ‘Y’ (from front view), and an electroless Cu plating solution (Macdermid M185) is filled therein. The heating part 422 is formed with a heating wire 422a and a slate 422b for heating the plating bath 421, and the temperature controlling part 423 having a temperature sensor 423a and a power source part 423b controls the temperature of the solution in the plating bath 421 and the heating part 422.

Also, at the lower end of the agitator 424, an agitating wing is formed to agitate the solution in the plating bath 421.

An electroless plating apparatus 420 as described above operates after an electroless Cu plating solution (Macdermid M185) is filled in the plating bath 421, the temperature controlling part 423 connected to the upper end of the plating bath 421 maintains the temperature of the electroless Cu plating solution at the temperature of 65° C., and the CNF powder treated through the third step 300 is inserted while air is induced into the air controlling part 425 connected to the lower end of the plating bath 421.

The amount of the CNF powder poured into is 0.05-0.3 g per 1 l of the electroless Cu plating solution, and the electroless plating apparatus 420 is operated for 10 minutes in order to uniformly plate a copper (Cu) on the CNF powder by an agitator 424 equipped in the upper end of the plating bath 421. Then, the blue color of the solution in the plating bath 421 becomes transparent.

Thereafter, the CNF powder mixed with the electroless Cu plating solution passing through the forth step 400 is filtered in the same manner as the filtration process performed after the second step 200.

FIGS. 3A and 3B show scanning electron microscope (SEM) photos of a CNF powder before treating through the dispersion and hydrophilic-treatment of the first step 100 and after the fourth step 400 in which the CNF/Cu composite powder transformed into an electroless Cu plated state.

The CNF powder prior to the first step 100 has a diameter of about 70-150 nm, whereas the CNF/Cu composite powder treated through the forth step 400 is a Cu plated state of the CNF with a diameter of about 300-400 nm.

In the CNF/Cu composite powder, not all of the CNF has been uniformly plated, and a partially unplated CNF may be observed. However, most of CNF is uniformly plated and maintain the independent dispersed fiber state without being agglomerated together.

After passing through the filtration process performed after the forth step 400, a fifth step 500 in which drying a CNF/Cu composite powder in a resistance furnace (not shown) is carried out.

In the fifth step 500, the CNF/Cu composite powder is placed in the resistance furnace, and dried for 12 hours by maintaining the temperature at 100° C.

After the fifth step 500 has been completed, a sixth step 600 in which a heat-treatment is carried out as the last step for removing an oxide film formed on the surface of a CNF/Cu composite powder during the electroless Cu plating process.

In the sixth step 600, the CNF/Cu composite powder is placed in a vacuum furnace (not shown), which is then maintained at a vacuum state of 10⁻² Torr while the interior temperature is maintained at 400° C. for the period of 3 hours.

FIG. 3C shows a scanning electron microscope (SEM) photo of the CNF/Cu composite powder after treated through the sixth step 600. As shown in FIG. 3C, the growth and coalescence of the composite powder due to the heat-treatment in vacuum has not occurred, and an independently dispersed fiber form has been maintained in the same manner as seen in the photo of the a CNF/Cu composite powder after passing through the forth step 400.

However, when compared to FIG. 3B, the surface shape of the composite powder has been changed due to a vacuum heat-treatment as shown in FIG. 3C. That is, in the electroless Cu plating process, a copper having a thin plate form was plated, thereby the surface became rough and uneven. However, the surface of the Cu plated on the CNF became comparatively smooth after the heat-treatment of the sixth step 600.

FIGS. 4A and 4B show X-ray diffraction spectrums of the composite powder after passing through the electroless Cu plating process of fifth step 500 and the composite powder after passing through a heat-treatment of sixth step 600, respectively.

As illustrated above, only a carbon (C) peak and a copper, (Cu) peak were observed in all of composite powders after passing through the above two steps, and other component peaks were not observed.

Accordingly, the reason for the dark brown color of a composite powder after the electroless Cu plating process has been changed to red color by heat treatment is due to a very thin layer of Cu-oxide (CuO, Cu₂O, etc.) formed on the surface of a composite powder during the plating process or the drying step after plating is reduced under a vacuum state, thereby a color of metal copper appeared.

As described above in detail, the process for fabricating a CNF/Cu composite powder by an electroless Cu plating of the present invention allows manufacturing a CNF/Cu composite powder by plating the surface of CNF with Cu using a conventional electroless Cu plating process

That is, the present invention is comprised of a filtration after dispersing and hydrophilic-treating a CNF, a filtration after catalyzing, a filtration/washing after accelerating, a filtration after an electroless Cu plating, and a heat-treatment after drying.

Accordingly, the application of the excellent mechanical and physical characteristics of a CNF, such as a high strength and elastic modulus, an excellent thermal conductivity and electric conductivity, to the fabrication of CNF/Cu composite material, whereby it is expected that a CNF/Cu composite powder manufactured according to the present invention is expended from the abrasion field such that it may be used as an electric contact material due to a high electric conductivity and thermal conductivity, and a high strength.

Also, the present invention using a commercialized electroless Cu plating process instead of a complicate process of a conventional composite powder has the effects of simplifying the process, so that a manufacturing cost is reduced.

It will be apparent to those skilled in the art that various modifications and variations can be made in the present invention. Thus, it is intended that the present invention covers the modifications and variations of this invention provided they come within the scope of the appended claims and their equivalents.

1. A process for fabricating a carbon nanofiber (CNF)/copper (Cu) composite powder by an electroless Cu plating, the process comprising the steps of:
a) dispersing and hydrophilic-treating a powder;
b) catalyzing the powder treated in the step a);
c) accelerating the powder treated in the step b);
d) carrying out an electroless Cu plating on the powder treated in the step c);
e) drying the treated powder in the step d); and
f) heat treating the powder treated in the step e).

2. The process according to claim 1, wherein the powder is a CNF.

3. The process according to claim 1, wherein the dispersing and hydrophilic-treating step is carried out with distilled water and an ultrasonic wave.

4. The process according to claim 1, wherein the catalyzing step is carried out with 0.2-3.0 g/l palladium chloride (PdCl₂), 10-40 g/l tin chloride (SnCl₂) and 100-200 ml/l hydrochloric acid (HCl) at 40° C. for 3 minutes.

5. The process according to claim 1, wherein the accelerating step is carried out with 750 ml distilled water and 150 ml sulfuric acid (H₂SO₄) at room temperature for 3 minutes.

6. The process according to claim 1, wherein the step d) is carried out by adding 0.05-0.3 g CNF per l to an electroless Cu plating solution and agitating the CNF and the electroless Cu plating solution at a temperature of 65° C. for 10 minutes.

7. The process according to claim 1, wherein the drying step is carried out at 100° C. for 12 hours.

8. The process according to claim 1, wherein the heat treating step is carried out at 400° C. for 3 hours in vacuum state.
